(19) United States
(12) Patent Application Publication
(10) Pub. No.: US 2023/0227279 A1
(43) Pub. Date: Jul. 20, 2023

(54) PAPER SIZE DETECTION USING ACTUATORS COMPRISING MULTIPLE OPERATING ARMS

(71) Applicant: Hewlett-Packard Development Company, L.P., Spring, TX (US)

(72) Inventors: Jun Bin IM, Seongnam-si (KR); Dang You KIM, Seongnam-si (KR); Jin Woo LEE, Seongnam-si (KR)

(73) Assignee: Hewlett-Packard Development Company, L.P., Spring, TX (US)

(21) Appl. No.: 18/011,631

(22) PCT Filed: May 6, 2021
(86) PCT No.: PCT/US2021/031078

§ 371 Date: Dec. 20, 2022

(30) Foreign Application Priority Data
Jul. 7, 2020 (KR) 10-2020-0083329

(51) Int. Cl. B65H 1/04; B65H 1/08; B41J 11/42; G03G 15/00

(52) U.S. Cl. CPC B65H 1/04; B65H 1/08; B41J 11/42; G03G 15/5029; B65H 2511/10; B65H 2553/61; B65H 2801/06

(57) ABSTRACT

A paper size detection device comprises a first actuator comprising a plurality of operating arms and a first detection arm to move in association with movement of the plurality of operating arms, the plurality of operating arms having lengths or angles different from each other; a first sensor to output different results in accordance with a position of the first detection arm; a second actuator comprising one operating arm and a second detection arm to move in association with movement of the one operating arm; and a second sensor to output different results in accordance with a position of the second detection arm.

### BACKGROUND

An image forming apparatus may refer to an apparatus for developing a black-and-white image or a color image on a paper according to an image signal and may include a laser printer, an ink jet printer, a copier, a multi-function peripheral, a facsimile, and the like.

### BRIEF DESCRIPTION OF THE DRAWINGS

FIG. 1 is a cross-sectional view schematically illustrating an image forming apparatus according to an example;

FIG. 2 is a perspective view schematically illustrating a first detection device among a plurality of detection devices included in a paper size detection device according to an example;

FIG. 3 is a side view for illustrating an operation of the detection device according to an example;

FIG. 4 is a cross-sectional view for illustrating an operation of the detection device according to an example;

FIG. 5 is a side view for illustrating an operation of the detection device according to an example;

FIG. 6 is a perspective view illustrating a paper size detection device according to an example;

FIG. 7 is a perspective view for illustrating a paper size detection device with an increased number of actuators according to an example;

FIG. 8 is a perspective view schematically illustrating a first detection device among a plurality of detection devices included in a paper size detection device according to another example;

FIG. 9 is a side view for illustrating an operation of the detection device according to the other example;

FIG. 10 is a side view for illustrating an operation of the detection device according to the other example;

FIG. 11 is a side view for illustrating an operation of the detection device according to the other example; and

FIG. 12 is a perspective view illustrating the paper size detection device according to the other example.

### DETAILED DESCRIPTION

Hereinafter, various examples will be described in detail with reference to the drawings. The examples described hereinafter may be modified and performed in various different aspects.

In the disclosure, the expression that a certain component is “connected” to another component not only includes a case where the components are “directly connected to each other”, but also a case where the components are “connected to each other with another component interposed therebetween”. In addition, when a certain component “includes” another certain component, it implies that a still another component may be further included, rather than excluding it, unless otherwise noted.

Further, an “image forming apparatus” may refer to an apparatus which prints print data generated on a terminal apparatus such as a computer on a recording printing medium. Examples of such an image forming apparatus may include a copier, a printer, a facsimile, a multi-function peripheral (MFP) serving functions of these in combination with one apparatus, and the like.

In addition, a “paper size detection device” may be a component included in the image forming apparatus and may be a device for identifying a size of a paper so that an image corresponding to a size of each paper is formed, when papers having various sizes are supplied to the image forming apparatus.

A paper size detection device of the present disclosure includes a plurality of operating arms. The paper size detection device of the present disclosure identifies various paper sizes using a minimal number of parts by applying a plurality of actuators to come into contact with different operating arms in accordance with a size of a paper.

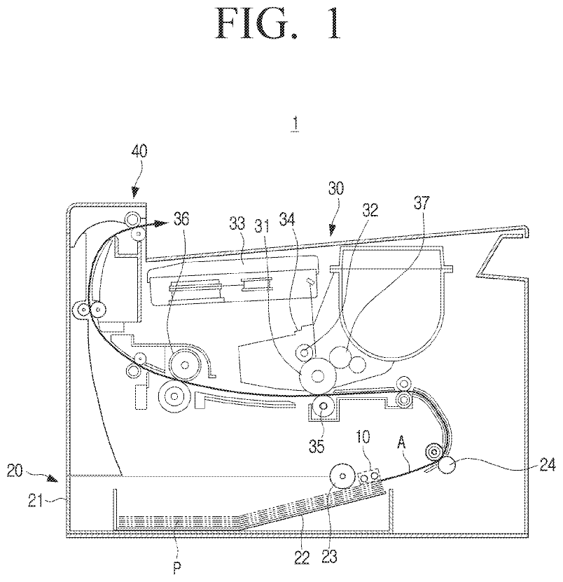

FIG. 1 is a cross-sectional view schematically illustrating an image forming apparatus according to an example.

The image forming apparatus may be implemented with various structures and functions in accordance with a size, cost, usage, a model type, and the like thereof. FIG. 1 illustrates an example of such structures.

Referring to FIG. 1, an image forming apparatus 1 may include a paper feeding device 20, a print engine 30, and a discharge device 40 and may further include a paper size detection device 10 for identifying a size of a paper P supplied from the paper feeding device 20. In addition, although not illustrated in FIG. 1, the image forming apparatus 1 may include a processor (not illustrated) for controlling the image forming apparatus 1, a memory (not illustrated), and the like.

The paper feeding device 20 may include a paper cassette 21, a knock-up plate 22 on which the papers P are stacked and which is installed on the paper cassette 21 to be rotatable in a vertical direction, a pick-up roller 23 for picking up the paper P stacked on the knock-up plate 22, and a transfer roller 24 for transferring the picked paper P to the print engine 30.

Referring to FIG. 1, the paper size detection device 10 according to an example may be installed in the paper cassette 21 to identify a size of the paper P fed by the paper feeding device 20. Meanwhile, a paper size detection device according to another example may be disposed on a transfer path A of the paper P to identify a size of the paper P being transferred.

The example of the paper size detection device 10 will be described in detail with reference to the drawings hereinafter, and a print process of the image forming apparatus 1 will be described schematically below.

The paper feeding device 20 may store the paper P and may feed the paper P to the print engine 30. The discharge device 40 may discharge the paper P, on which an image is formed through the print engine 30, outside of the image forming apparatus 1.

The print engine 30 may form an image on the paper P fed from the paper feeding device 20. In this case, the print engine 30 may form an image on the paper P by electrophotography.

The print engine 30 may include a photosensitive drum 31, a charging device 32, an exposing device 33, a developing device 34, a transfer device 35, and a fixing device 36. The photosensitive drum 31 is an example of a photosensitive body and the type of the photosensitive body is not limited thereto, and the photosensitive drum 31 may be implemented as a photosensitive belt in a belt shape.

Hereinafter, for convenience of description, a configuration of the print engine 30 corresponding to one color will be described as an example, but in the implementation, the print engine may include a plurality of photosensitive drums, a plurality of charging devices, a plurality of exposing devices, and a plurality of developing devices corresponding to a plurality of colors, an intermediate transfer belt, and the like.

A surface of the photosensitive drum 31 may be charged with a uniform potential by the charging device 32 and an electrostatic latent image corresponding to an image to be printed may be formed on an outer peripheral surface thereof in response to light emitted from the exposing device 33. A toner in the developing device 34 may be supplied to the photosensitive drum 31, on which the electrostatic latent image is formed, by a developing roller 37 and a visual image may be developed on the outer peripheral surface of the photosensitive drum 31.

Meanwhile, the paper P may be transferred along a transfer path A. For example, the paper P stacked on the top of the paper cassette 21 may be picked up by the pick-up roller 23 and transferred by the transfer roller 24 to pass between the photosensitive drum 31 and the transfer device 35. In this case, a toner image developed on the outer peripheral surface of the photosensitive drum 31 may be transferred to a surface of the paper P facing the photosensitive drum 31. The toner image transferred to the paper P may be fixed on the paper P by thermocompression bonding through the fixing device 36, and the paper P, on which the toner image is fixed, may be discharged by the discharge device 40 outside of the image forming apparatus 1.

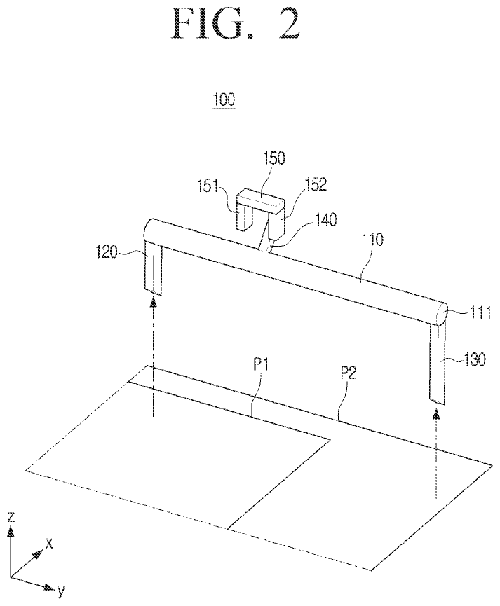

Hereinafter, the paper size detection device according to an example will be described with reference to FIGS. 2 to 7.

FIG. 2 is a perspective view schematically illustrating a first detection device 100 among a plurality of detection devices included in the paper size detection device 10 according to an example.

Referring to FIG. 2, the first detection device 100 may include a first actuator 110 and a first sensor 150.

The first actuator 110 may include a first shaft 111 rotatable around a first rotation axis, a plurality of operating arms 120 and 130 and a first detection arm 140 connected to the first shaft 111.

The plurality of operating arms may include a first operating arm 120 and a second operating arm 130. In this case, the operating arms 120 and 130 may be disposed on the first shaft 111 to be spaced apart with an interval and may be formed to extend downward.

The first detection arm 140 may be connected to the first shaft 111 to rotate at the same angle as the first operating arm 120 and the second operating arm 130. The first detection arm 140 may be disposed in a detection region where the first sensor 150 is able to detect the first detection arm 140 or a non-detection region where the first detection arm 140 is not able to be detected, in accordance with the rotation angle.

The first sensor 150 may be an optical sensor including a light emitting element 151 and a light receiving element 152. In this case, the light emitting element 151 may emit light toward the light receiving element 152 to detect whether an object is present in a detection region between the light emitting element 151 and the light receiving element 152.

Accordingly, when the first detection arm 140 rotates to be disposed in the detection region between the light emitting element 151 and the light receiving element 152, the first sensor 150 may detect the first detection arm 140 and output a signal corresponding thereto.

Any one of the plurality of operating arms may come into contact with the paper P stacked on the knock-up plate 22 by a lifting operation of the knock-up plate 22 (see FIG. 1) of the paper feeding device 20. In this case, the paper size detection device 10 including the first detection device 100 may be installed on an upper portion of the knock-up plate 22.

For example, the knock-up plate 22 may move the paper stacked in the paper cassette 21 to a paper feeding position. In this case, the first operating arm 120 may extend toward the paper feeding position to a first length and the second operating arm 130 may extend toward the paper feeding position to a second length that is longer than the first length.

The first operating arm 120 and the second operating arm 130 may be disposed in sequence in a direction farther away from the center of the paper transfer path. Accordingly, referring to FIG. 2, when a paper P1 having a first size is lifted by the knock-up plate 22, the paper P1 may come into contact with the first operating arm 120, and when a paper P2 having a second size that is larger than the first size is lifted by the knock-up plate 22, the paper P2 may come into contact with the second operating arm 130. The second operating arm 130 is formed to be longer than the first operating arm 120, and accordingly, the paper P2 having the second size may come into contact with the second operating arm 130 first. Therefore, the paper P2 may come into contact with the second operating arm 130, without contact with the first operating arm 120.

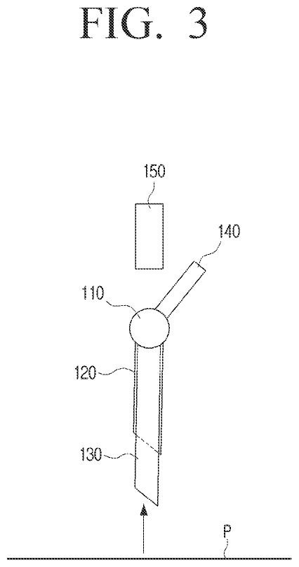

Hereinafter, an operation of an actuator according to a size of a paper to be contacted will be described with reference to FIGS. 3 to 5.

FIGS. 3 to 5 are side views for illustrating the operation of the detection device according to an example.

FIG. 3 is a side view illustrating a state before the paper P is fed to the paper feeding position by the knock-up plate 22. Referring to FIG. 3, the first operating arm 120 and the second operating arm 130 may extend downward to the paper P and the second operating arm 130 may be longer than the first operating arm 120.

Meanwhile, an end of each of the first operating arm 120 and the second operating arm 130 may be tapered so that each of the first operating arm 120 and the second operating arm 130 rotates around a rotation axis of the actuator 110, when coming into contact with the paper P. In this case, since the first operating arm 120, the second operating arm 130, and the first detection arm 140 are connected to the actuator 110, if any one of the first operating arm 120 and the second operating arm 130 rotates, the first operating arm 120, the second operating arm 130, and the first detection arm 140 may rotate at the same angle at the same time.

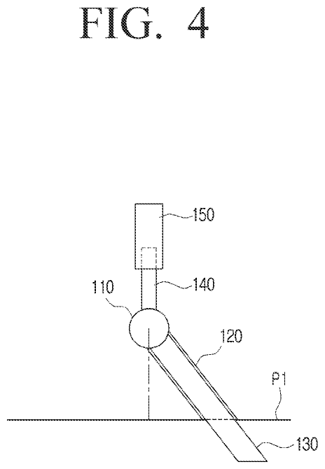

FIG. 4 is a side view illustrating a state where, when the paper P1 having the first size is fed to the paper cassette 21, the paper P1 having the first size is lifted to the paper feeding position by the knock-up plate 22 to come into contact with the first operating arm 120.

Referring to FIG. 4, the first operating arm 120 may come into contact with the paper P1 having the first size and rotate at a certain angle. Accordingly, the first detection arm 140 connected to the actuator 110 may rotate at the same angle as the rotation angle of the first operating arm 120 to be disposed in the detection region of the first sensor 150.

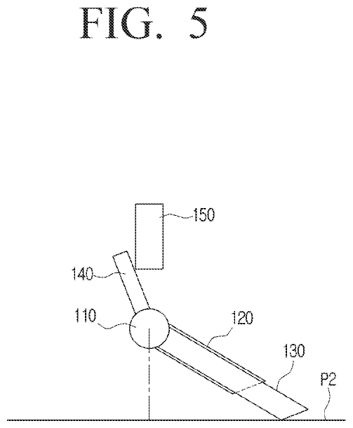

Meanwhile, FIG. 5 is a side view illustrating a state where, when the paper P2 having the second size is fed to the paper cassette 21, the paper P2 having the second size is lifted to the paper feeding position by the knock-up plate 22 to come into contact with the second operating arm 130.

Referring to FIG. 5, the second operating arm 130 may come into contact with the paper P2 having the second size and rotate at a certain angle. In this case, since the second operating arm 130 is formed to be longer than the first operating arm 120, when the paper P2 having the second size is lifted to the paper feeding position to come into contact with the second operating arm 130, the second operating arm 130 may rotate at an angle larger than the angle at which the first operating arm 120 comes into contact with the paper P1 having the first size and rotates.

Accordingly, the first detection arm 140 connected to the actuator 110 may rotate at the same angle as the rotation angle of the second operating arm 130. In this case, referring to FIG, 5, the first detection arm 140 may rotate at a larger angle, compared to the case where the operating arm comes into contact with the paper P1 having the first size, and accordingly, the first detection arm 140 may pass the detection region of the first sensor 150 and may be disposed in the non-detection region.

The first sensor 150 may output different results depending on the position of the first detection arm 140. For example, when the first detection arm 140 is disposed in the detection region of the first sensor150 as illustrated in FIG. 4, the first sensor 150 may output a value of 1, and when the first detection arm 140 is disposed in the non-detection region of the first sensor 150 as illustrated in FIGS, 3 and 5, the first sensor 150 may output a value of 0.

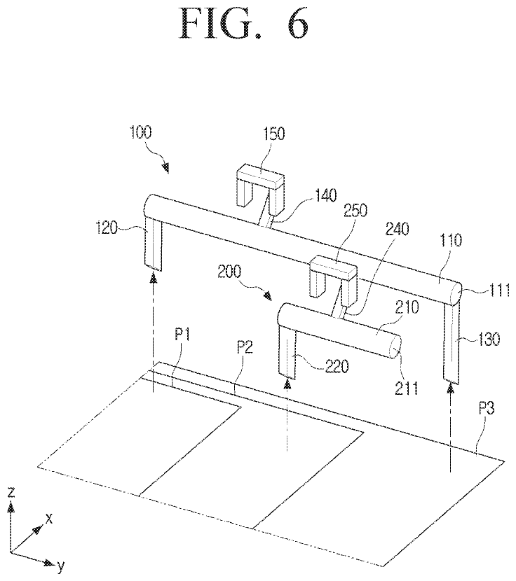

The paper size detection device according to an example may output different signals from a sensor when coming into contact with each of the paper P1 having the first size or the paper P2 having the second size using one actuator and one sensor. Hereinafter, a paper size detection device including a plurality of actuators and sensors, the device for identifying more types of paper sizes than the number of sensors by combining signals output from the plurality of sensors be described with reference to FIG. 6.

FIG. bis a perspective view illustrating a paper size detection device according to an example.

The paper size detection device 10 may include a first detection device 100 including a first actuator 110 and a first sensor 150, and a second detection device 200

The first detection device 100 has been described above with reference to FIGS. 2 to 5, and therefore the overlapped description will not be repeated.

The second detection device 200 may include a second actuator 210 and a second sensor 250.

The second actuator 210 may include a second shaft 211 rotatable around a second rotation axis formed to be parallel with the first rotation axis of the first actuator 110, and a third operating arm 220 and a second detection arm 240 connected to the second shaft 211. In this case, the third operating arm 220 may be formed to extend downward from the second shaft 211.

The second detection arm 240 may be connected to the second shaft 211 to rotate at the same anode as the third operating arm 220 The second detection arm 240 may be disposed in a detection region where the second sensor 250 is able to detect the second detection arm 240 or a non-detection region where the second detection arm 240 is not able to be detected, in accordance with the rotation angle.

The second sensor 250 may be an optical sensor, like the first sensor 150. Accordingly, when the second detection arm 240 rotates to be disposed in the detection region of the second sensor 250, the second sensor 250 may detect the second detection arm 240 and output a signal corresponding thereto.

The third operating arm 220 may come into contact with the paper P moved to the paper feeding position by the lifting operation of the knock-up plate 22 (see FIG, 1).

In this case, the third operating arm 220 may extend toward the paper feeding positionto have the first length that is same length as the first operating arm 120. Accordingly, when the third operating arm 220 comes into contact with the paper P, the second detection arm 240 may be disposed in the detection region of the second sensor 250 by rotating at the same angle as the angle, at which the first detection arm 140 rotates when the first operating arm 120 of the first actuator 110 conies into contact with the paper P (see FIG, 4).

Meanwhile, the first operating arm 120, the third operating arm 220, and the second operating arm 130 may be disposed in sequence in a direction farther away from the center of the paper transfer path. Accordingly, referring to FIG. 6, when the paper P1 having the first size is lifted by the knock-up plate 22, the paper P1 may come into contact with the first operating arm 120, and when the paper P2 having the second size that is larger than the first size is lifted by the knock-up plate 22, the paper P2 may come into contact with the third operating arm 220. In addition, when a paper P3 having a third size that is larger than the second size is lifted by the knock-up plate 22, the paper P3 may come into contact with the second operating arm 130.

1n this case, the paper P1 having the first size comes into contact with the first operating arm 120 and does not come into contact with the third operating arm 220 and the second operating arm 130. Accordingly, when the paper P1 having the first size is fed, the first sensor 150 may output a value of 1 and the second sensor 250 may output a value of 0.

Meanwhile, since the first operating arm 120 and the third operating arm 220 are formed to have the same length, the paper P2 having the second size may come into contact with both the first operating arm 120 and the third operating arm 220. Accordingly, when the paper P2 having the second size is fed, both the first sensor 150 and the second sensor 250 may output a value of 1.

Since the second operating arm 130 is formed to be longer than the first operating arm 120, when the paper P3 having the third size comes into contact with the first actuator 110, the first detection arm 140 may be disposed in the non-detection region of the first sensor 150 by rotating at an angle larger than the case where the paper P1 having the first size comes into contact with the first operating arm 120 (see FIG. 5). Meanwhile, when the paper P3 having the third size comes into contact with the second actuator 210. the paper P3 may come into contact with the third operating arm 220, and accordingly, the second detection arm 240 may be disposed in the detection region of the second sensor 250 (see FIG. 4). Therefore, when the paper P3 having the third size is fed, the first sensor 150 may output a value of 0 and the second sensor 250 may output a value of 1.

A processor included in the image forming apparatus 1 may confirm a size of a paper based on a signal value output from the first sensor 150 and the second sensor 250.

For example, the processor may identify that the paper cassette 21 is empty without paper, when the signal output from each of the first sensor 150 and the second sensor 250 is 0, identify the paper P1 having the first size, when the value of the first sensor 150 is 1 and the value of the second sensor 250 is 0, identify the paper P2 having the second size, when the value of the first sensor 150 is 1 and the value of the second sensor 250 is 1, and identify the paper P3 having the third size, when the value of the first sensor 150 is 0 and the value of the second sensor 250 is 1.

Accordingly, the processor may identify whether the paper cassette 21 is empty without paper and the papers having three types of sizes through the two actuators and the two sensors, and accordingly, the processor may identify four cases in total. The output value of the first and second sensors 150 and 250 according to each case may be represented in the table below.

TABLE 1

| | First sensor | Second sensor |
|---|---|---|
| EMPTY | 0 | 0 |
| Sheet (P1) having first size | 1 | 0 |
| Sheet (P2) having second size | 1 | 1 |
| Sheet (P3) having third size | 0 | 1 |

As described above, two sensors and two actuators rather than three sensors and three actuators are used to identify the papers having three sizes through the paper size detection device according to an example. Accordingly, in the example of the present disclosure, cost is reduced by removing materials included in a product and power consumption is reduced by minimizing the number of optical sensors.

Meanwhile, by increasing the number of actuators and sensors according to an example, papers having four or more sizes may be identified. Even in this case, the sizes of the papers may be identified using the number of actuators and sensors smaller than the number of actuators and sensors used in the related art to identify the same number of paper sizes.

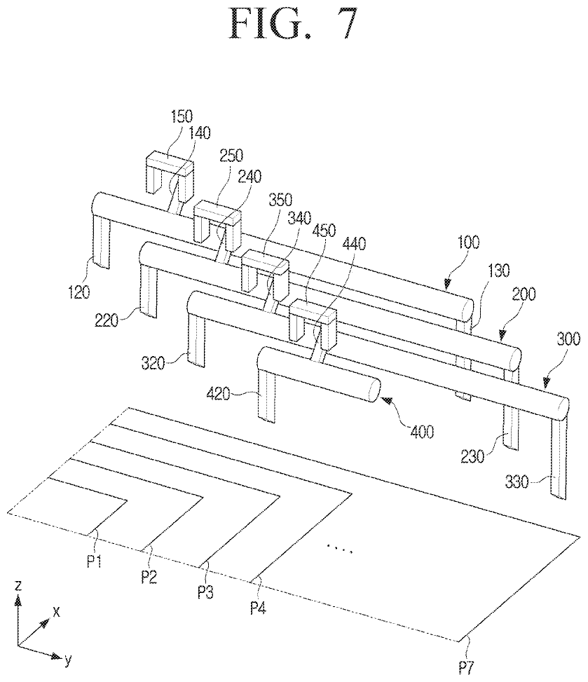

FIG. 7 is a perspective view for illustrating a paper size detection device with an increased number of actuators according to an example.

Referring to FIG. 7, the paper size detection device may include first to fourth detection devices 100, 200, 300, and 400 disposed in parallel, and the first to third detection devices 100, 200, and 300 may include operating arms 120, 220, and 320 having the first length, and operating arms 130, 230 and 330 having the second length longer than the first length, respectively. Meanwhile, the fourth detection device 400 may include an operating arm 420 having the first length.

As described above with reference to FIGS. 2 to 6 in advance, the operating arm coming into contact with the paper may vary in each actuator depending on the size of the paper, and values output from each sensor may be different. When the paper comes into contact with the operating arm having the first length, the sensor may output a value of 1 (see FIG. 4), and when the paper does not come into contact with the actuator or comes into contact with the operating arm having the second length, the sensor may output a value of 0 (see FIGS. 3 and 5).

In the case of the paper size detection device illustrated in FIG. 7, the paper size detection device may identify the empty case without the paper and papers having seven types of sizes through the four actuators and the four sensors, and accordingly, the paper size detection device may identify eight cases in total. The output value of first to fourth sensors 150, 250, 350, and 450 according to each case may be represented in the table below.

TABLE 2

| | First | Second | Third | Fourth |
|---|---|---|---|---|
| | sensor | sensor | sensor | sensor |
| EMPTY | 0 | 0 | 0 | 0 |
| Sheet P1 having first size | 1 | 0 | 0 | 0 |
| Sheet P2 having second size | 1 | 1 | 0 | 0 |
| Sheet P3 having third size | 1 | 1 | 1 | 0 |
| Sheet P4 having fourth size | 1 | 1 | 1 | 1 |
| Sheet P5 having fifth size | 0 | 1 | 1 | 1 |
| Sheet P6 having sixth size | 0 | 0 | 1 | 1 |
| Sheet P7 having seventh size | 0 | 0 | 0 | 1 |

When expanding the paper size detection device according to an example, in order to distinguish the empty case and papers having N types of sizes, in other words, in order to identify N+1 cases, (N+1)/2 sensors and actuators may be used (herein, the number below the decimal point is rounded off). Accordingly, it is possible to reduce product production cost by minimizing the number of components used for paper size detection.

The paper size detection device according to another example may be disposed on a transfer path A of the paper (see FIG. 1), not at the paper feeding position, and may identify the size of the paper P being transferred.

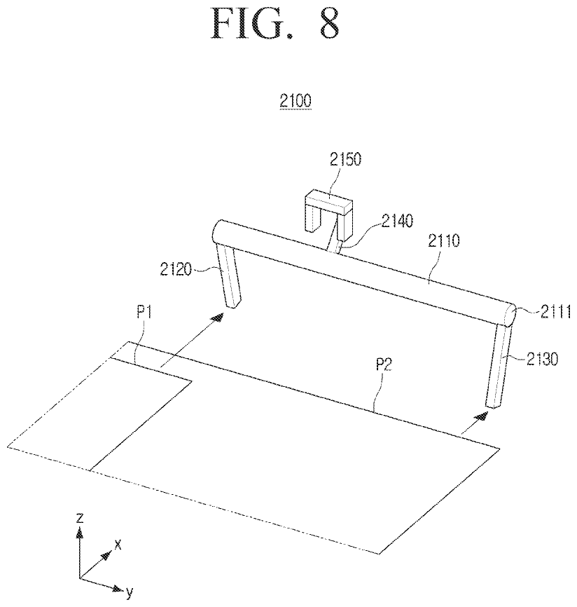

Hereinafter, the paper size detection device according to the other example will be described with reference to FIGS. 8 to 12.

FIG. 8 is a perspective view schematically illustrating a first detection device 2100 among a plurality of detection devices included in the paper size detection device according to the other example.

Referring to FIG. 8, the first detection device 2100 may include a first actuator 2110 and a second sensor 2150.

The first actuator 2110 may include a first shaft 2111 rotatable around a first rotation axis, a plurality of operating arms 2120 and 2130 and a first detection arm 2140 connected to the first shaft 2111.

The plurality of operating arms may include a first operating arm 2120 and a second operating arm 2130. In this case, the operating arms 2120 and 2130 may be disposed on the first shaft 2111 to be spaced apart with an interval and may be formed at different positions with respect to a circumferential direction of the first shaft 2111. For example, the first operating arm 2120 may be disposed to tilt at a first angle with respect to a transfer path (+X axis direction) of the paper and the second operating arm 2130 may be disposed to tilt at a second angle that is larger than the first angle with respect to the transfer path (+X axis direction) of the paper,

The first detection arm 2140 may be connected to the first shaft 2111 to rotate at the same angle as the first operating arm 2120 and the second operating arm 2130, The first detection arm 2140 may be disposed in a detection region where the first sensor 2150 is able to detect the first detection arm 2140 or a non-detection region where the first detection arm 2140 is not able to be detected, in accordance with the rotation angle.

The first sensor 2150 may output a signal corresponding to the position of the first detection arm 2140. The operation of the first sensor 2150 is the same as the operation of the sensor described above with reference to FIGS. 2 to 7, and therefore the overlapped description will not be repeated.

The plurality of operating arms may be disposed in the transfer path A of the paper and any one of the plurality of operating arms may come into contact with the paper P when the paper passes through the transfer path.

The first operating arm 2120 and the second operating arm 2130 may be disposed in sequence in a direction farther away from the center of the paper transfer path. Accordingly, referring to FIG. 8, when the paper P1 having the first size is transferred, the paper P1 may come into contact with the first operating arm 2120, and when the paper P2 having the second size that is larger than the first size is transferred, the paper P2 may come into contact with the second operating arm 2130. Since the operating arm 2130 is formed to have a larger angle with respect to the transfer path (+X axis direction) of the paper than the first operating arm 2120, in other words, the operating arm 2130 is formed at the upstream of the transfer path of the paper, the paper P2 having the second size may come into contact with the second operating arm 2130 first. Accordingly, the paper P2 may come into contact with the second operating arm 2130, without contact with the first operating arm 2120.

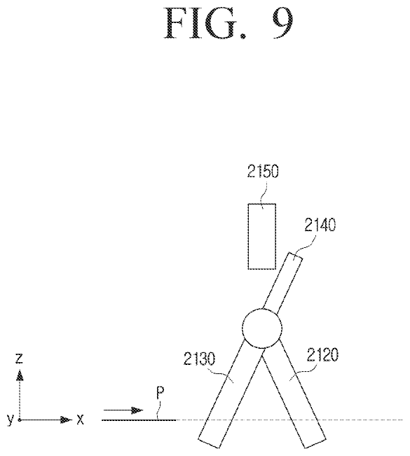

Hereinafter, an operation of the actuator according to a size of a paper to be contacted will be described with reference to FIGS. 9 to 11.

FIGS. 9 to 11 are side views for illustrating the operation of the detection device according to another example.

FIG. 9 is a side view illustrating a state before the paper P comes into contact with the actuator while being transferred along the transfer path.

Referring to AG. 9, the first operating arm 2120 and the second operating arm 2130 may be disposed in the transfer path of the paper P, the first operating arm 2120 may be disposed to tilt at the first angle with respect to the transfer path (+X axis direction) of the paper, and the second operating arm 2130 may be disposed to tilt at the second angle larger than the first angle with respect to the transfer path (+X axis direction) of the paper.

The first operating arm 2120 and the second operating arm 2130 may be disposed in the transfer path of the paper P so as to rotate around a rotation axis of the actuator 2110, when coming into contact with the paper P. In this case, since the first operating arm 2120, the second operating arm 2130, and the first detection arm 2140 are connected to the actuator 2110, if any one of the first operating arm 2120 and the second operating arm 2130 rotates, the first operating arm 2120, the second operating arm 2130, and the first detection arm 2140 may rotate at the same angle at the same time.

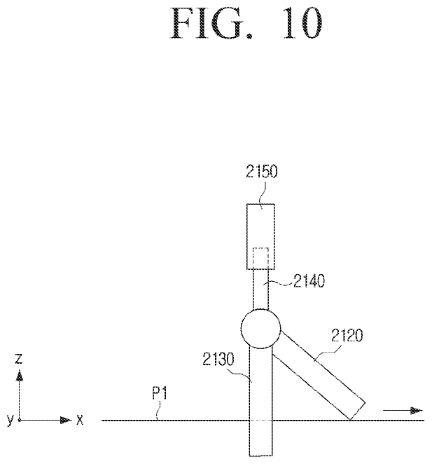

FIG. 10 is a side view illustrating a state where the paper P1 having the first size is transferred and comes into contact with the first operating arm 2120 while being transferred.

Referring to FIG. 10, the first operating arm 2120 may come into contact with the paper P1 having the first size and rotate at a certain angle. Accordingly, the first detection arm 2140 connected to the actuator 2110 may rotate at the same angle as the rotation angle of the first operating arm 2120 to be disposed in the detection region of the first sensor 2150.

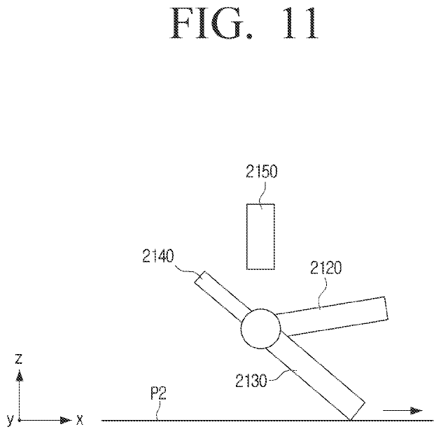

Meanwhile, FIG. 11 is a side view illustrating a state where the paper P2 having the second size is transferred and comes into contact with the second operating arm 2130 while being transferred.

Referring to FIG. 11, the second operating arm 2130 may come into contact with the paper P2 having the second size and rotate at a certain angle. In this case, since the second operating arm 2130 is formed at the upstream of the transfer path of the paper than the first operating arm 2120, when the paper P2 having the second size comes into contact with the second operating arm 2130, the second operating arm 2130 may rotate at an angle larger than the angle at which the first operating arm 2120 comes into contact with the paper P1 having the first size and rotates.

Accordingly, the first detection arm 2140 connected to the actuator 2110 may rotate at the same angle as the rotation angle of the second operating arm 2130. In this case, referring to FIG. 11, the first detection arm 2140 may rotate at a larger angle, compared to the case where the operating arm comes into contact with the paper P1 having the first size, and accordingly, the first detection arm 2140 may pass the detection region of the first sensor 2150 and may be disposed in the non-detection region.

The first sensor 2150 may output different results depending on the position of the first detection arm 2140. For example, when the first detection arm 2140 is disposed in the detection region of the first sensor 2150 as illustrated in FIG. 10, the first sensor 2150 may output a value of 1, and when the first detection arm 2140 is disposed in the non-detection region of the first sensor 2150 as illustrated in FIGS. 9 and 11, the first sensor 2150 may output a value of 0.

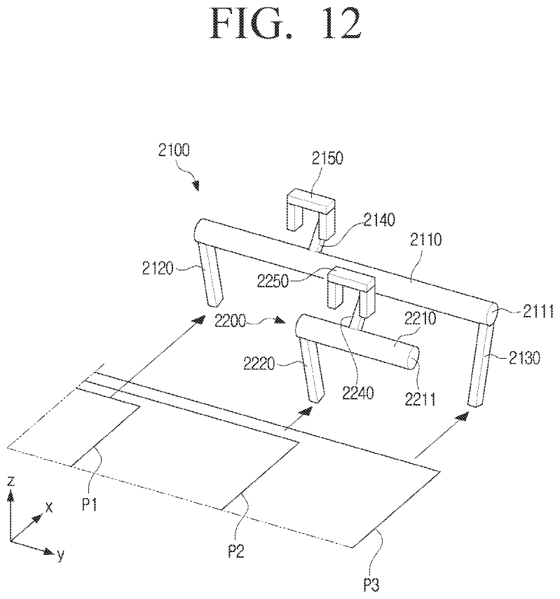

The paper size detection device according to an example may output different signals from a sensor hen coming into contact with each of the paper P1 having the first size or the paper P2 having the second size using one actuator and one sensor. Hereinafter, a paper size detection device including a plurality of actuators and sensors, the device for identifying more types of paper sizes than the number of sensors by combining signals output from the plurality of sensors will be described with reference to FIG. 12.

FIG. 12 is a perspective view illustrating a paper size detection device according to another example.

The paper size detection device may include the first detection device 2100 including the first actuator 2110 and the second sensor 2150, and a second detection device 2200.

The first detection device 2100 has been described above with reference to FIGS. 8 to 11, and therefore the overlapped description will not be repeated.

The second detection device 2200 may include a second actuator 2210 and a second sensor 2250.

The second actuator 2210 may include a second shaft 2211 rotatable around a second rotation axis formed to be parallel with the first rotation axis of the first actuator 2110, and a third operating arm 2220 and a second detection arm 2240 connected to the second shaft 2211.

The second detection arm 2240 may be connected to the second shaft 2211 to rotate at the same angle as the third operating arm 2220. The second detection arm 2240 may be disposed in a detection region where the second sensor 2250 is able to detect the second detection arm 2240 or a non-detection region where the second detection arm 2240 is not able to be detected, in accordance with the rotation angle.

The third operating arm 2220 may be disposed in the transfer path of the paper P. In this case, the third operating arm 2220 may be formed to have the same angle as the first operating arm 2120 with respect to the transfer path (+X axis direction) of the paper. Accordingly, when the third operating arm 2220 comes into contact with the paper P, the second detection arm 2240 may be disposed in the detection region of the second sensor 2250 by rotating at the same angle as the angle, at which the first detection arm 2140 rotates when the first operating arm 2120 of the first actuator 2110 comes into contact with the paper P (see FIG. 10).

Meanwhile, the first operating arm 2120, the third operating arm 2220, and the second operating arm 2130 may be disposed in sequence in a direction farther away from the center of the paper transfer path. Accordingly, referring to FIG. 12, when the paper P1 having the first size is transferred, the paper P1 may come into contact with the first operating arm 2120, and when the paper P2 having the second size that is larger than the first size is transferred, the paper P2 may come into contact with the third operating arm 2220. In addition, when the paper P3 having the third size larger than the second size is transferred, the paper P3 may come into contact with the second operating arm 2130.

In this case, the paper P1 having the first size comes into contact with the first operating arm 2120 and does not come into contact with the third operating arm 2220 and the second operating arm 2130. Accordingly, when the paper P1 having the first size is fed, the first sensor 2150 may output a value of 1 and the second sensor 2250 may output a value of 0.

Meanwhile, since the first operating arm 2120 and the third operating arm 2220 are formed to have the same angle with respect to the transfer path (+X axis direction) of the paper, the paper P2 having the second size may come into contact with both the first operating arm 2120 and the third operating arm 2220. Accordingly, when the paper P2 having the second size is fed, both the first sensor 2150 and the second sensor 2250 may output a value of 1.

Since the second operating arm 2130 is formed at the upstream of the paper transfer path than the first operating arm 2120, when the paper P3 having the third size comes into contact with the first actuator 2110, the first detection arm 2140 may be disposed in the non-detection region of the first sensor 2150 by rotating at an angle larger than the case where the paper P1 having the first size comes into contact with the first operating arm 2120 (see FIG. 11). Meanwhile, when the paper P3 having the third size comes into contact with the second actuator 2210, the paper P3 may come into contact with the third operating arm 2220, and accordingly, the second detection arm 2240 may be disposed in the detection region of the second sensor 2250 (see FIG. 10). Therefore, when the paper P3 having the third size is fed, the first sensor 2150 may output a value of 0 and the second sensor 2250 may output a value of 1.

The processor included in the image forming apparatus 1 may confirm a size of a paper based on a signal value output from the first sensor 2150 and the second sensor 2250.

Accordingly, the processor may identify whether the transfer path is empty without paper being transferred, and the papers having three types of sizes through the two actuators and the two sensors, and accordingly, the processor may identify four cases in total.

As described above, two sensors and two actuators rather than three sensors and three actuators are used to identify the papers having three sizes through the paper size detection device according to the other example. Accordingly, in the examples of the present disclosure, cost is reduced by removing materials included in a product and power consumption is reduced through minimizing the number of optical sensors.

Meanwhile, by increasing the number of actuators and sensors according to the other example, papers having four or more sizes may be identified. Even in this case, the sizes of the papers may be identified using the number of actuators and sensors smaller than the number of actuators and sensors used in the related art to identify the same number of paper sizes. The increase of the number of cases to be identified according to the increase of the number of actuators and sensors is the same as described above with reference to FIG. 7, and therefore the overlapped description will not be repeated.

The disclosure has been described above with the exemplified method. The terms used herein are for description and should not be understood as limited meanings. Various modifications and changes of the disclosure can be performed according to the above description. Therefore, unless otherwise noted, the disclosure may be practiced freely within the scope of the appended claims.

What is claimed is:

1. A paper size detection device comprising:
a first actuator comprising a plurality of operating arms and a first detection arm to move in association with movement of the plurality of operating arms, the plurality of operating arms having lengths or angles different from each other;
a first sensor to output different results in accordance with a position of the first detection arm;
a second actuator comprising one operating arm and a second detection arm to move in association with movement of the one operating arm; and
a second sensor to output different results in accordance with a position of the second detection arm.

2. The paper size detection device according to claim 1, wherein the first actuator comprises:
a first operating arm of the plurality of operating arms to come into contact with a paper having a first size; and
a second operating arm of the plurality of operating arms to come into contact with a paper having a second size, the second operating arm being longer than the first operating arm.

3. The paper size detection device according to claim 2, wherein the second actuator comprises a third operating arm to come into contact with a paper having a third size, and
wherein the first operating arm, the third operating arm, and the second operating arm are in sequence in a direction farther away from a center of a paper transfer path.

4. The paper size detection device according to claim 2, wherein the first detection arm is at a first position when the first and second operating arms are not in contact with a paper, the first detection arm is at a second position when the first operating arm is in contact with the paper having the first size, and the first detection arm is at a third positionwhen the second operating arm is in contact with the paper having the second size.

5. The paper size detection device according to claim 2, wherein an end of each of the first operating arm and the second operating arm is tapered so that each of the first operating arm and the second operating arm rotates when in contact with the paper.

6. The paper size detection device according to claim 1, wherein the first actuator comprises:
a first operating arm of the plurality of operating arms to come into contact with a paper having a first size and to tilt at a first angle with respect to a transfer path of a paper; and
a second operating arm of the plurality of operating armsto come into contact with a paper having a second size and to tilt at a second angle with respect to the transfer path.

7. The paper size detection device according to claim 6, wherein the second actuator comprises a third operating arm of the plurality of operating arms to come into contact with a paper having a third size, and
wherein the first operating arm, the third operating arm, and the second operating arm are in sequence in a direction farther away from the center of the paper transfer path.

8. The paper size detection device according to claim 7, wherein the third operating arm to tilt at the first angle with respect to the transfer path.

9. The paper size detection device according to claim 6, wherein the second angle is larger than the first angle.

10. An image forming apparatus comprising:
a paper cassette on which a paper is stacked;
a plurality of detection devices to detect a size of the paper stacked on the paper cassette; and
a processor to confirm the size of the paper based on a signal value output from a plurality of sensors,
wherein a first detection device among the plurality of detection devices comprises a first operating arm to come into contact with a paper having a first size, a second operating arm to come into contact with a paper having a second size, a first detection arm to rotate in association with movement of the first and second operating arms, and a first sensor to output different result in accordance with rotation of the first detection arm.

11. The image forming apparatus according to claim 10, comprising:
a knock-up plate to move the paper stacked in the paper cassette to a paper feeding position,
wherein the first operating arm extends toward the paper feeding position to have a first length, and
wherein the second operating arm extends toward the paper feeding position to have a second length that is longer than the first length.

12. The image forming apparatus according to claim 11, wherein a second detection device among the plurality of detection devices comprises:
a second actuator comprising a third operating arm to come into contact with a paper having a third size and a second detection arm to move in association with movement of the third operating arm; and
a second sensor to output different results in accordance with a position of the second detection arm,
wherein the first operating arm, the third operating arm, and the second operating arm are in sequence in a direction farther away from a center of a paper transfer path.

13. The image forming apparatus according to claim 10, comprising:
a paper feeding device to move the paper stacked in the paper cassette in a paper transfer direction,
wherein the first operating arm to tilt at a first angle with respect to a transfer path of a paper, and
wherein the second operating arm to tilt at a second angle with respect to the transfer path.

14. The image forming apparatus according to claim 13, wherein a second detection device among the plurality of detection devices comprises:
a second actuator comprising a third operating arm to come into contact with a paper having a third size and a second detection arm to move in association with movement of the third operating arm; and
a second sensor to output different results in accordance with a position of the second detection arm,
wherein the first operating arm, the third operating arm, and the second operating arm are in sequence in a direction farther away from the center of the paper transfer path.

15. The image forming apparatus according to claim 13, wherein the second angle is larger than the first angle.
